(19) United States
(12) Patent Application Publication
(10) Pub. No.: US 2017/0332009 A1
(43) Pub. Date: Nov. 16, 2017

(54) DEVICES, SYSTEMS, AND METHODS FOR A VIRTUAL REALITY CAMERA SIMULATOR

(71) Applicants: Canon Canada Inc., Mississauga (CA); Canon U.S.A., Inc., Melville, NY (US)

(72) Inventor: Fan Zhang, Halifax (CA)

(21) Appl. No.: 15/592,079

(22) Filed: May 10, 2017

Related U.S. Application Data
(60) Provisional application No. 62/334,829, filed on May 11, 2016.

(51) Int. Cl. H04N 5/232; H04N 5/235; H04N 5/445; G06F 1/16; G06F 3/01

(52) U.S. Cl. CPC H04N 5/23216; H04N 5/44543; H04N 5/2353; H04N 5/23293; H04N 5/23225; G06F 3/012; G06F 1/1637; G06F 1/163

(57) ABSTRACT

Devices, systems, and methods receive a user selection of a camera option; receive a user selection of a lens option; generate first images of a scene according to one or more specifications of the corresponding camera, respective values of camera settings, one or more specifications of the corresponding lens, and respective values of lens settings; send the first images to a head-mounted display device; receive a new value for a selected camera setting or a selected lens setting; generate second images of the scene according to the one or more specifications of the corresponding camera, the respective values of the camera settings, the one or more specifications of the corresponding lens, and the respective values of the lens settings, wherein the respective values of the camera settings or the respective values of the lens settings include the new value; and send the second images to a head-mounted display device.

### CROSS-REFERENCE TO RELATED APPLICATIONS

This application claims the benefit of U.S. Application No. 62/334,829, which was filed on May 11, 2016.

### BACKGROUND

### Technical Field

This description generally relates to virtual reality.

### Background

Computer technologies that implement virtual reality can generate images that simulate a real environment and images that create an imaginary environment. Virtual reality also simulates the physical presence of a viewer in the environment.

### SUMMARY

Some embodiments of a device comprise one or more computer-readable media and one or more processors that are coupled to the one or more computer-readable media. The one or more processors are configured to cause the device to receive a user selection of a camera option, wherein the camera option describes one or more specifications of a corresponding camera; receive a user selection of a lens option, wherein the lens option describes one or more specifications of a corresponding lens; generate first images of a scene according to the one or more specifications of the corresponding camera, respective values of camera settings, the one or more specifications of the corresponding lens, and respective values of lens settings; send the first images to a head-mounted display device; receive an input that indicates a new value for a selected camera setting or a selected lens setting; update the value of the selected camera setting or the selected lens setting to the new value; generate second images of the scene according to the one or more specifications of the corresponding camera, the respective values of the camera settings, the one or more specifications of the corresponding lens, and the respective values of the lens settings, wherein the respective values of the camera settings or the respective values of the lens settings include the new value; and send the second images to a head-mounted display device.

Some embodiments of one or more computer-readable storage media store computer-executable instructions that, when executed by one or more computing devices, cause the one or more computing devices to perform operations that comprise receiving a user selection of a camera option, wherein the camera option describes one or more specifications of a corresponding camera; receiving a user selection of a lens option, wherein the lens option describes one or more specifications of a corresponding lens; generating a virtual scene; generating first images of the virtual scene according to the one or more specifications of the corresponding camera, respective values of camera settings, the one or more specifications of the corresponding lens, and respective values of lens settings; sending the first images to a head-mounted display device; receiving an input that indicates a new value for a selected camera setting or a selected lens setting; updating the value of the selected camera setting or the selected lens setting to the new value; generating second images of the virtual scene according to the one or more specifications of the corresponding camera, the respective values of the camera settings, the one or more specifications of the corresponding lens, and the respective values of the lens settings, wherein the respective values of the camera settings or the respective values of the lens settings include the new value; and sending the second images to a head-mounted display device.

Some embodiments of a method comprise receiving a user selection of a camera option, wherein the camera option describes one or more specifications of a corresponding camera; receiving a user selection of a lens option, wherein the lens option describes one or more specifications of a corresponding lens; generating a virtual scene; generating first images of the virtual scene according to the one or more specifications of the corresponding camera, respective values of camera settings, the one or more specifications of the corresponding lens, and respective values of lens settings; sending the first images to a head-mounted display device; receiving an input that indicates a new value for a selected camera setting or a selected lens setting; updating the value of the selected camera setting or the selected lens setting to the new value; generating second images of the virtual scene according to the one or more specifications of the corresponding camera, the respective values of the camera settings, the one or more specifications of the corresponding lens, and the respective values of the lens settings, wherein the respective values of the camera settings or the respective values of the lens settings include the new value; and sending the second images to a head-mounted display device.

### BRIEF DESCRIPTION OF THE DRAWINGS

FIG. 1 illustrates an example embodiment of a virtual-reality camera-simulator system.

FIG. 2A illustrates an example embodiment of an interface image that includes a menu.

FIG. 2B illustrates an example embodiment of an interface image that includes a camera-selection menu.

FIG. 3A illustrates an example embodiment of an interface image that includes additional information about the corresponding camera of a camera option.

FIG. 3B illustrates an example embodiment of an interface image that includes additional information about the corresponding camera of a camera option.

FIG. 4A illustrates an example embodiment of an interface image that includes a lens-selection menu.

FIG. 4B illustrates an example embodiment of an interface image that includes additional information about the lens that corresponds to a lens option.

FIG. 5A illustrates an example embodiment of an interface image that includes a camera-simulation display.

FIG. 5B illustrates an example embodiment of an interface image that includes a camera-simulation display.

FIG. 6A illustrates an example embodiment of an interface image that includes a camera-simulation display.

FIG. 6B illustrates an example embodiment of an interface image that includes a camera-simulation display.

FIG. 7 illustrates an example embodiment of an operational flow for simulating a camera in a virtual environment.

FIG. 8 illustrates an example embodiment of a virtual-reality camera-simulator system.

FIG. 9 illustrates the scripts that can be used to implement the operations of some embodiments of a virtual-reality camera-simulator system.

FIG. 10 illustrates the general flow of information in some embodiments of a virtual-reality camera-simulator system.

FIG. 11 illustrates the menu and mode organization in some example embodiments of a virtual-reality camera-simulator system.

FIG. 12 illustrates an example embodiment of an operational flow for menu and mode transitions.

### DESCRIPTION

The following paragraphs describe explanatory embodiments. Other embodiments may include alternatives, equivalents, and modifications. Additionally, the explanatory embodiments may include several novel features, and a particular feature may not be essential to some embodiments of the devices, systems, and methods that are described herein.

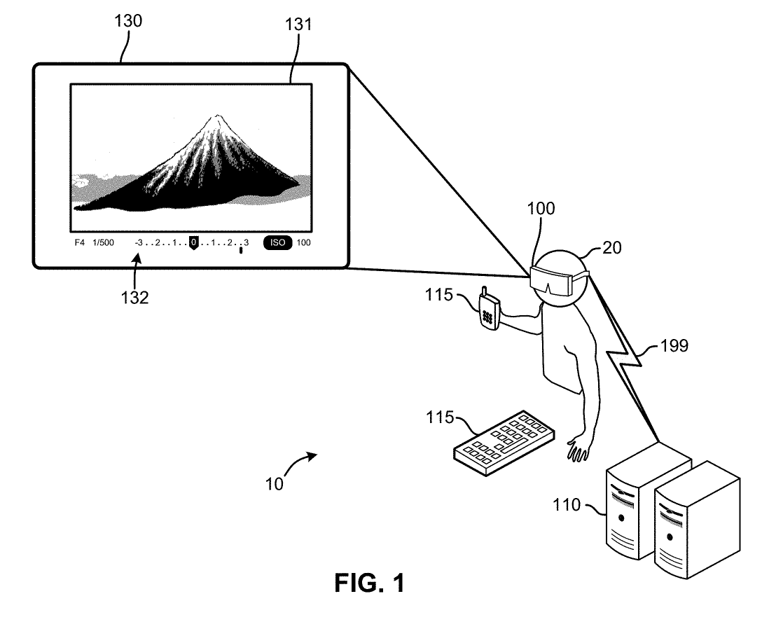

FIG. 1 illustrates an example embodiment of a virtual-reality camera-simulator system 10. The system 10 includes a head-mounted display device 100; one or more image-generation devices 110, which are specially-configured computing devices; and one or more input devices 115 (e.g., a mouse, a game controller). In this embodiment, the input devices 115 include a keyboard and a remote control. The head-mounted display device 100, the one or more image-generation devices 110, and the input devices 115 communicate by means of one or more wired or wireless channels 199. In FIG. 1, the head-mounted display device 100 is worn by a user 20, and the head-mounted display device 100 presents an interface image 130. This example of an interface image 130 includes an image of a scene 131 and camera-setting information 132. The user 20 can change the interface image 130 by using one or more of the input devices 115 or the head-mounted display device 100 (e.g., by changing the position or the orientation of the head-mounted display device 100).

The head-mounted display device 100 can display interface images 130 that present a virtual-reality camera simulator that allows the user 20 to test different cameras and lenses in a virtual environment. The specifications of the selected camera and the selected lens, as well as the selected values of the settings of the selected camera and the selected lens, may all affect the image of the scene 131.

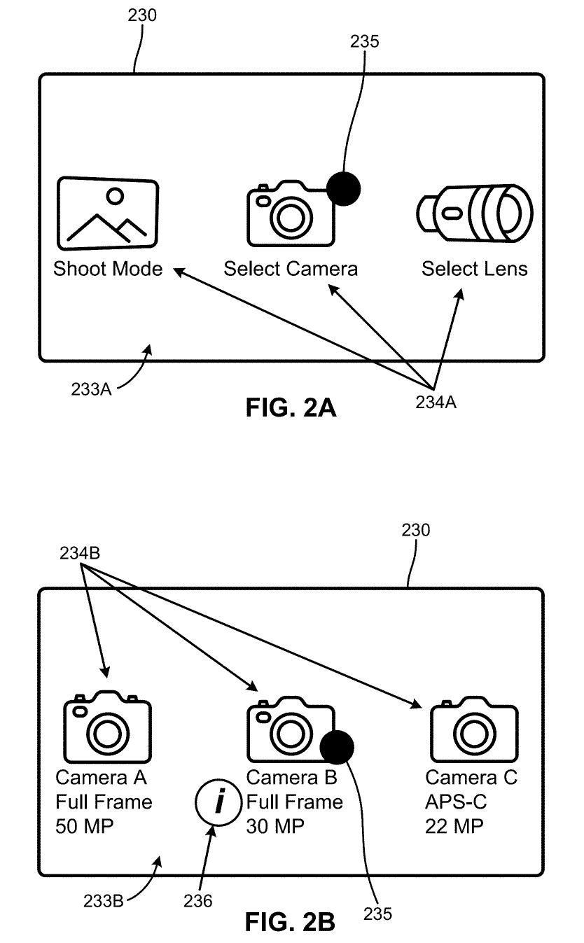

FIG. 2A illustrates an example embodiment of an interface image 230 that includes a menu 233A. This interface image 230 may be the first image that is displayed when a virtual-reality camera-simulator system is started. The menu 233A includes the following menu options 234A: “shoot mode,” “select camera,” and “select lens.” This embodiment of the interface image 230 also includes a cursor 235. The cursor 235 may be permanently shown at the center of the interface image 230, and a user may move the cursor 235 by moving the head-mounted display device (e.g., by turning his head), although FIG. 2A does not include a cursor 235 that is permanently shown at the center of the interface image 230. When the cursor 235 hovers over an interactable part of the interface image 230, for example a menu option 234A, then the interactable part may change color or opacity, or the interactable may be highlighted in some other way. While the cursor 235 hovers over a menu option 234A, a user can select the menu option 234A by inputting a command to the system. For example, the command may be input by pressing a button on a remote, pressing a button on a keyboard, or pressing a button on the head-mounted display device.

FIG. 2B illustrates an example embodiment of an interface image 230 that includes a camera-selection menu 233B. Some embodiments of the system cause the head-mounted display device to display the camera-selection menu 233B if the “select camera” menu option in FIG. 2A is selected. The camera-selection menu 233B includes camera options 234B, each of which indicates a camera that can be simulated by the system. This embodiment of a camera-selection menu 233B displays three camera options 234B, as well as information about each camera that corresponds to one of the camera options 234B. In some embodiments, the camera-selection menu 233B displays information (e.g., camera name, sensor size) about a camera only when the cursor 235 hovers over the corresponding camera option 234B. A user may select one of the camera options 234B by moving the cursor 235 over the camera option 234B and inputting a command to the system, and some embodiments of the system center the interface image 230 on a selected camera option 234B in response. Also, if the camera-selection menu 233B is too large to be displayed in its entirety, a user may scroll through the camera-selection menu 233B by moving the head-mounted display device left or right (e.g., by turning her head, by tilting her head) or by inputting a command via an input device (e.g., an arrow key on a keyboard).

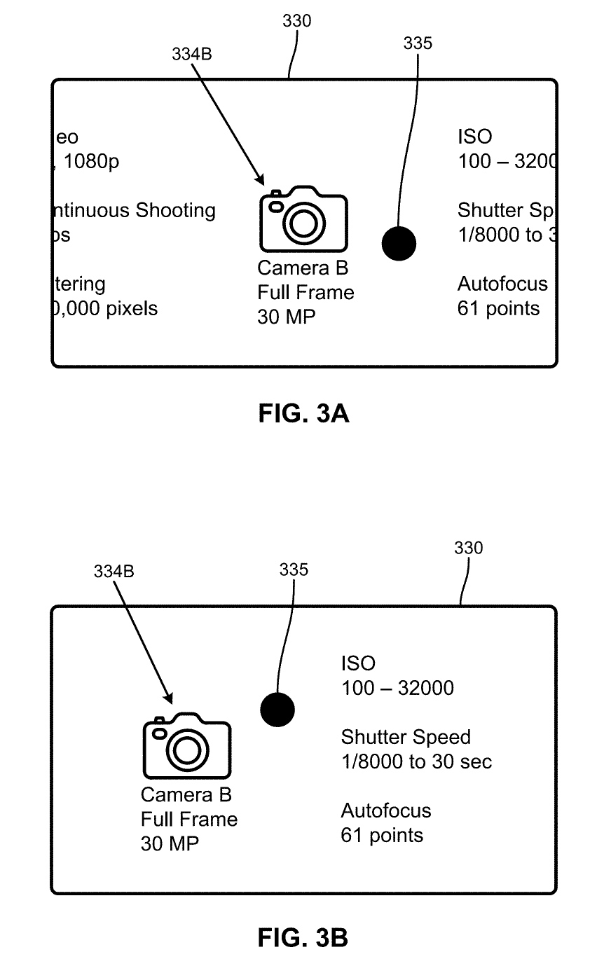

Furthermore, in this embodiment, the interface image 230 displays an additional-information button 236 next to a camera option 234B when the cursor 235 hovers over the camera option. In some embodiments, a respective additional-information button 236 is displayed next to every camera option 234B that appears in the camera-selection menu 233B. Selecting the additional-information button 236 will cause the head-mounted display device to present an interface image that displays additional information about the camera that corresponds to the camera option 234B, for example as shown in FIG. 3A. A user may return to the camera-selection menu 233B by inputting a command to the system, for example by pressing a backspace key.

FIG. 3A illustrates an example embodiment of an interface image 330 that includes additional information about the corresponding camera of a camera option 334B. The additional information includes detailed specifications about the camera. If all of the additional information does not fit in the interface image 330 at once, then a user can scroll the additional information (e.g., scroll left or right) by moving the head-mounted display device or by inputting a command via an input device. For example, FIG. 3B, which illustrates an example embodiment of an interface image 330 that includes additional information about the corresponding camera of a camera option 334B, shows the additional information in FIG. 3A after the view has been moved to the right, which scrolls the additional information to the left.

After a camera selection has been received in the camera-selection menu 233B, the system may cause the head-mounted display device to again present the interface image 230 that includes the menu 233A in FIG. 2A. Or the system may automatically display an interface image that includes a lens-selection menu.

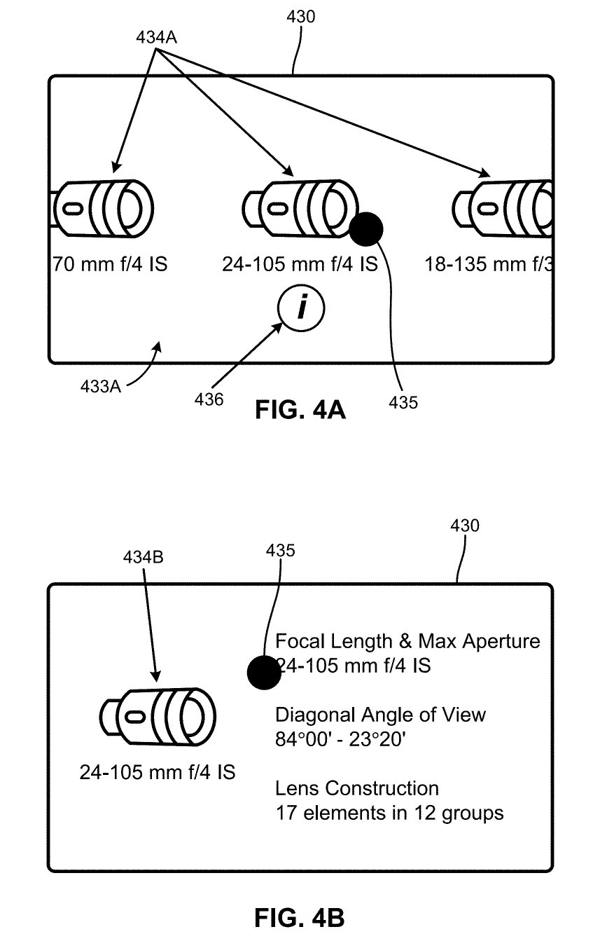

FIG. 4A illustrates an example embodiment of an interface image 430 that includes a lens-selection menu 433A. Some embodiments of the system cause the head-mounted display device to display the lens-selection menu 433A in response to the selection of the “select lens” option in FIG. 2A. This embodiment of a lens-selection menu 433A includes three lens options 434A. The lens-selection menu 433A may operate in the same way as, or in a way similar to, the camera-selection menu 233B in FIG. 2B. A user can select a lens option 434A by hovering a cursor 435 over the lens option 434A and entering a “select” command. Also, a user can select an additional-information button 436 to cause the head-mounted display device to display additional information about the corresponding lens of a lens option 434A. FIG. 4B illustrates an example embodiment of an interface image 430 that includes additional information about the lens that corresponds to a lens option 434B.

After a lens selection has been received, the system may cause the head-mounted display device to present the interface image 230 that includes the menu 233A in FIG. 2A.

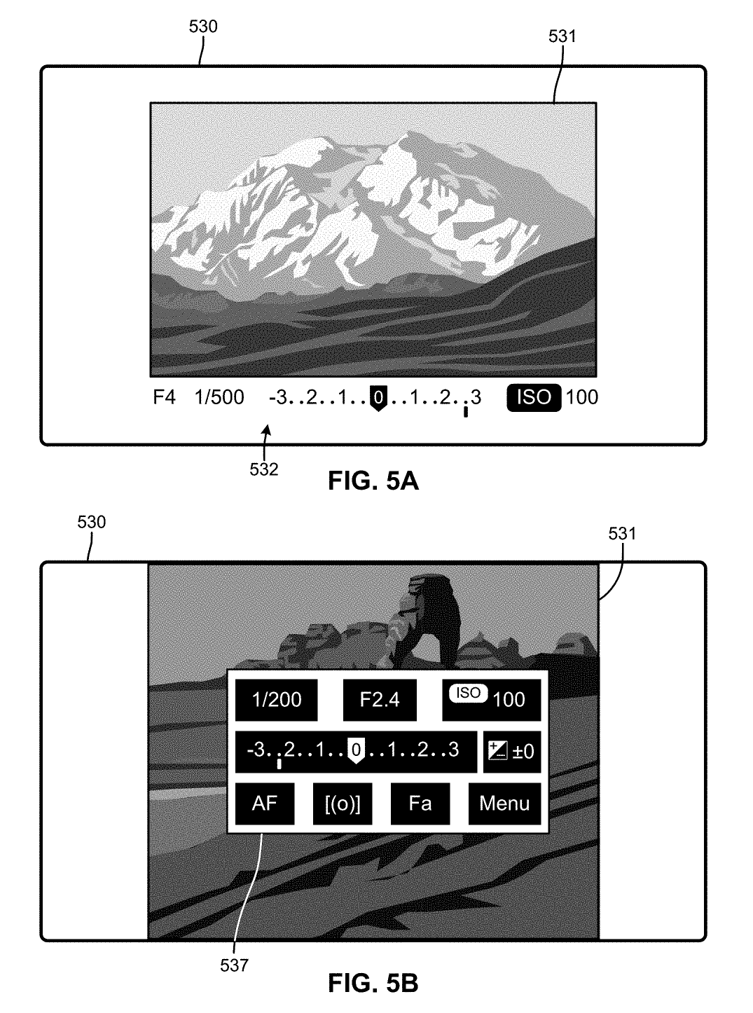

If the “shoot mode” option 234A is selected from the menu 233A in FIG. 2A, then, in response, some embodiments of the system cause the head-mounted display device to display an interface image that includes a camera-simulation display. FIG. 5A illustrates an example embodiment of an interface image 530 that includes a camera-simulation display. This embodiment of a camera-simulation display includes an image of a scene 531 and camera-setting information 532 (e.g., shutter speed, ISO, an exposure meter). The image of the scene 531 may be entirely computer generated, may be an image of a physical scene (e.g., a live image) that was captured by a camera (e.g., a camera on the head-mounted display device), or may be an image that combines an image of a physical scene with computer-generated imagery. The image of the scene 531 is shown from the perspective of the viewfinder of the selected camera, and thus the image of the scene 531 is also referred to herein at the “viewfinder image 531.”

The viewfinder image 531 may be larger if the selected camera has a larger sensor, and the zoom of the viewfinder image 531 may depend on the focal length of the selected lens. Additionally, the viewfinder may be more similar to an electronic viewfinder or a live view than an optical viewfinder. Furthermore, the viewfinder image 531 may show the scene as the scene would appear in a captured photo. For example, the system may simulate effects such as depth of field, motion blur, and noise in the viewfinder image 531. The viewfinder image 531 may include an overlay that shows where the autofocus points are located.

A user can command the system to autofocus to an object in the viewfinder image 531 (e.g., at the center of the viewfinder image 531) by activating a control on an input device or the head-mounted display device, for example by pressing and holding down a button or a key. The user may also input commands to cause the system to simulate the manual adjustment of the focus by using one or more controls on an input device or the head-mounted display device, for example by using the left and right arrow keys. Additionally, the user can input commands to cause the system to adjust the zoom if the selected lens is able to zoom, for example by using the up and down arrow keys. Furthermore, the user can input commands to cause the system to capture an image of the view shown in the viewfinder image 531, for example by pressing the space key, thereby producing a captured image. The captured image can simulate how the scene would appear if the scene was captured using the selected camera and the selected lens at the selected values of the settings.

Moreover, although some specific input means are described herein (e.g., the arrow keys to adjust focus or zoom, the space key to capture an image), some embodiments of the devices and systems use different input means.

While the viewfinder image 531 is displayed, the user can input a command to cause the system to display a settings menu, for example the settings menu 537 shown in FIG. 5B, which illustrates an example embodiment of an interface image 530 that includes a camera-simulation display. The settings menu 537 may be the equivalent of the quick menu on some physical cameras, for example the settings menu on some physical cameras that is opened by pressing the button labeled with a Q. The settings menu 537 allows the user to change the values of various settings of the camera.

The user can navigate around the settings menu 537 by inputting commands to the system, for example by using the arrow keys or by moving a cursor. The user can adjust the value of a setting by selecting the setting's menu icon. Upon selection, the icon may indicate its selected status, for example by changing color or becoming outlined. Once a setting's menu icon is selected, the user is able to adjust the setting's value by inputting commands to the system, for example by using the up and right keys to increase the value, and by using the down and left keys to decrease the value. The user can confirm the new value of the setting, for example by using the space key or the return key.

The values of the settings in the settings menu 537 influence the appearance of the viewfinder image 531, as well as the appearance of captured images. For example, if the value of the aperture is adjusted to the lowest available value (e.g., f/1.8), some areas of the scene in the viewfinder image 531 may appear to be blurry. If the value of the aperture setting is adjusted to a larger value (e.g., f/9.0), then most, or all, of the scene may be in focus in the viewfinder image 531. Also for example, in some embodiments, the effect of the value of the shutter speed on a captured image can be seen by slightly shaking the head-mounted display device. Using a very slow shutter speed (e.g., 0.3 seconds) causes the captured image to be blurred. Additionally for example, in some embodiments increasing the ISO to a high value (e.g., 3200) causes noise to appear in the viewfinder image 531 and the captured image.

The user can also input a command to remove the settings menu 537 from the viewfinder image 531, for example by navigating to one of the bottom-row icons in the settings menu 537 and then pressing the down-arrow key, which may cause the system to slide the settings menu 537 downwards and out of view.

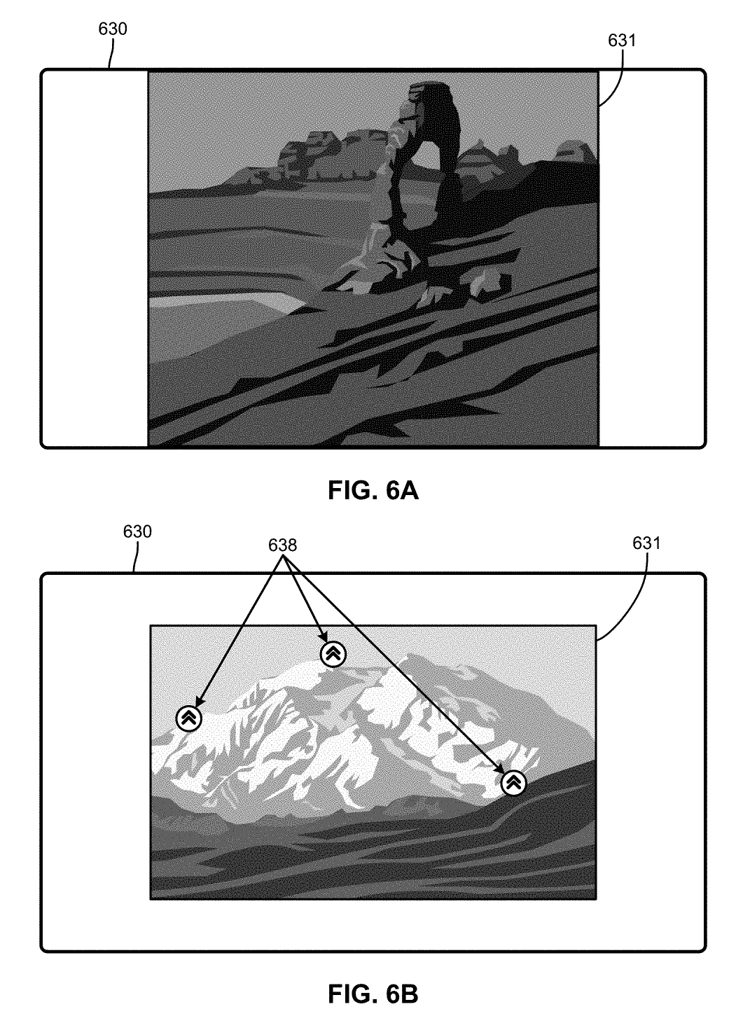

FIG. 6A, which illustrates an example embodiment of an interface image 630 that includes a camera-simulation display, shows a viewfinder image 631 when the settings menu has been hidden. Also, the interface image 630 in the embodiment of FIG. 6A does not show camera-setting information. Some embodiments of the system allow a user to toggle between an interface image 630 that shows the camera-setting information (e.g., the interface image 530 in FIG. 5A) and an interface image 630 that does not show the camera-setting information (e.g., the interface image 630 in FIG. 6A).

FIG. 6B illustrates an example embodiment of an interface image that includes a camera-simulation display. In this embodiment, the interface image 630 shows a viewfinder image 631 that includes waypoint markers 638. Waypoint markers 638 are buttons that are displayed in the virtual environment. A user can select a waypoint marker 638 to move the user to the location of the waypoint marker 638 in the virtual environment, which allows the user to view the scene from a different perspective. In some embodiments, a user can select a waypoint marker 638 by centering the waypoint marker 638 in the view and then inputting a command (e.g., pressing a space key). In some embodiments, the waypoint markers 638 are not displayed when the settings menu is displayed or when the camera-setting information is displayed.

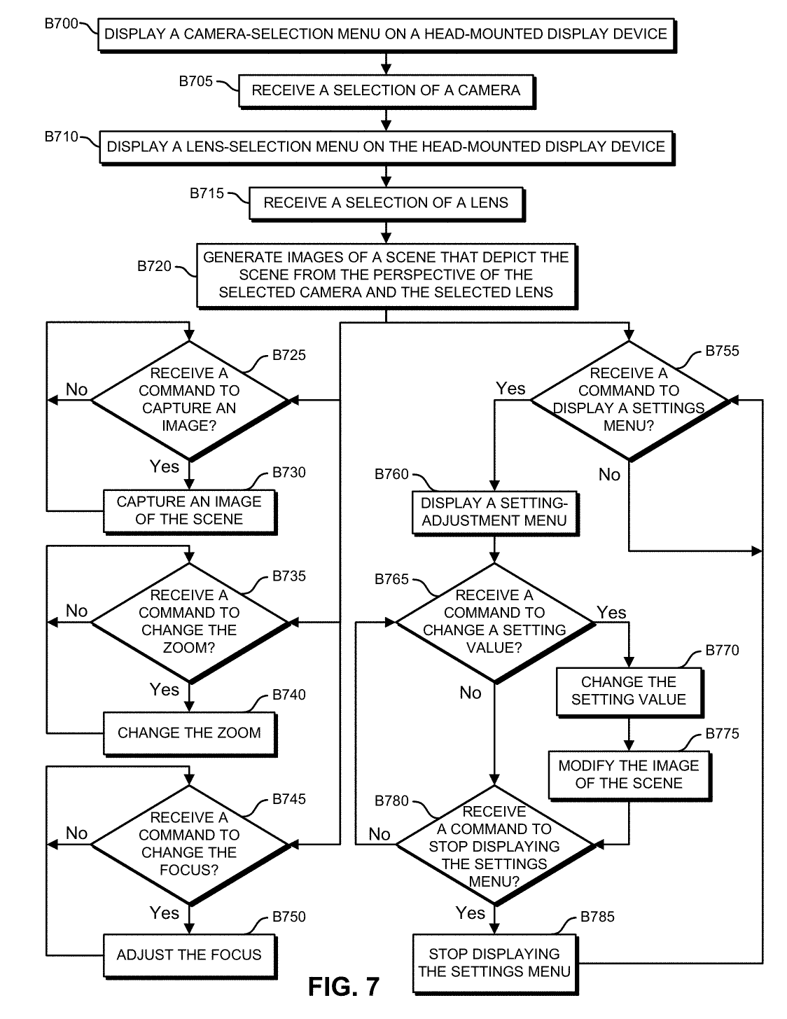

FIG. 7 illustrates an example embodiment of an operational flow for simulating a camera in a virtual environment. Although this operational flow and the other operational flows that are described herein are each presented in a certain order, some embodiments of these operational flows may perform at least some of the operations in different orders than the presented orders. Examples of possible different orderings include concurrent, overlapping, reordered, simultaneous, incremental, and interleaved orderings. Thus, other embodiments of the operational flows that are described herein may omit blocks, add blocks, change the order of the blocks, combine blocks, or divide blocks into more blocks.

Furthermore, although this operational flow and the other operational flows that are described herein are performed by a virtual-reality camera-simulator system, other embodiments of these operational flows may be performed by one or more other specially-configured computing devices.

The flow starts in block B700, where a virtual-reality camera-simulator system displays a camera-selection menu on a head-mounted display device. Next, in block B705, the system receives a selection of a camera. The flow then moves to block B710, where the system displays a lens-selection menu on the head-mounted display device. Then the flow proceeds to block B715, where the system receives a selection of a lens. Next, in block B720, the system generates images of a scene that depict the scene from the perspective of the selected camera and the selected lens, and the camera-simulator system displays the images on the head-mounted display device. The images of the scene indicate how the scene would appear from the perspective of the selected camera and the selected lens when the settings of the selected camera are set to their current values and when the settings of the selected lens are set to their current values.

The camera-simulator system allows the user to change the view of the scene by changing the position or the orientation of the head-mounted display device. The flow then branches into four flows: a first flow, a second flow, a third flow, and a fourth flow. The camera-simulator system may simultaneously perform the first flow, the second flow, the third flow, and the fourth flow.

From block B720, the first flow moves to block B725, where the system determines if it has received a command to capture an image of the scene. If not (block B725=No), then the first flow waits at block B725. If yes (block B725=Yes), then in block B730 the system captures an image of the scene based on the specifications of the camera, the specifications of the lens, the values of the camera settings, and the values of the lens settings. The first flow then returns to block B725.

From block B720, the second flow moves to block B735, where the system determines if it has received a command to change the zoom of the lens. If not (block B735=No), then the second flow waits at block B735. If yes (block B735=Yes), then in block B740 the system changes the zoom of the lens according to the received command and modifies the images of the scene according to the changed zoom. The second flow then returns to block B735.

From block B720, the third flow moves to block B745, where the system determines if it has received a command to change the focus of the lens. If not (block B745=No), then the third flow waits at block B745. If yes (block B745=Yes), then in block B750 the system changes the focus of the lens according to the received command and modifies the images of the scene according to the changed focus. The third flow then returns to block B745.

From block B720, the fourth flow moves to block B755, where the system determines if it has received a command to display a settings menu. If not (block B755=No), then the fourth flow waits at block B755. If yes (block B755=Yes), then the fourth flow proceeds to block B760, where the system displays a settings menu.

The fourth flow then moves to block B765, where the system determines if it has received a command to change the value of a setting. If yes (block B765=Yes), then the fourth flow moves to block B770. In block B770, the system changes the value of the setting according to the received command, and in block B775 the system modifies the images of the scene according to the changed value of the setting. The fourth flow then proceeds to block B780.

Also, if in block B765 the system determines that it has not received a command to change the value of a setting (block B765=No), then the fourth flow moves to block B780.

In block B780, the system determines if it has received a command to stop displaying the settings menu. If not (block B780=No), then the fourth flow returns to block B765. If yes (block B780=Yes), then the fourth flow moves to block B785. In block B785, the system stops displaying the settings menu, and then the fourth flow returns to block B755. Furthermore, although the values of only the zoom and the focus can be changed without using the settings menu in this example embodiment, in some embodiments the values of different settings than focus and zoom can be changed without using the settings menu.

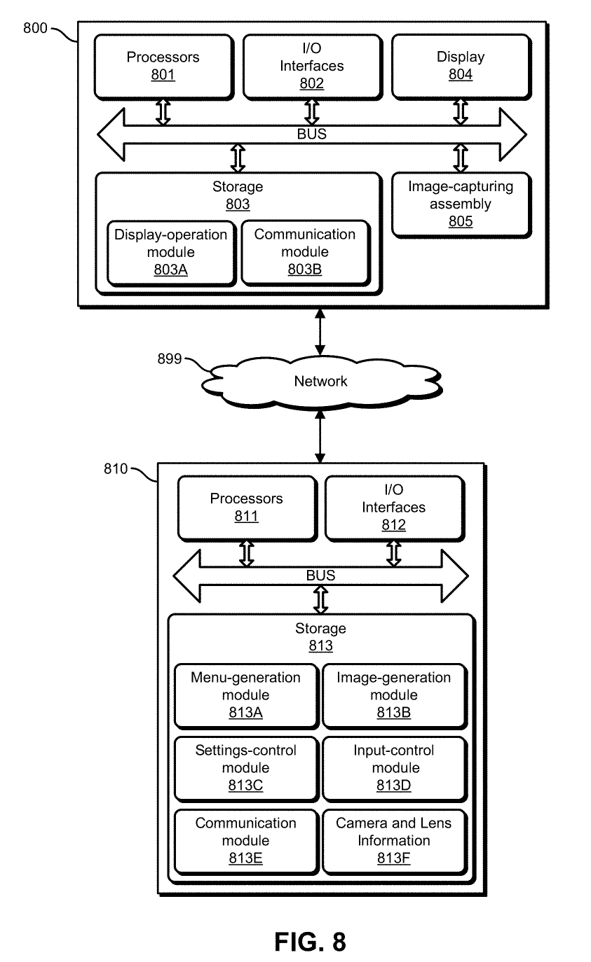

FIG. 8 illustrates an example embodiment of a virtual-reality camera-simulator system. The system includes a head-mounted display device 800 and an image-generation device 810. In this embodiment, the devices communicate by means of one or more networks 899, which may include a wired network, a wireless network, a LAN, a WAN, a MAN, and a PAN. Also, in some embodiments the devices communicate by means of other wired or wireless channels.

The head-mounted display device 800 includes one or more processors 801, one or more I/O interfaces 802, storage 803, a display 804 (e.g., an LCD panel, and LED panel, and OLED panel), and, optionally, an image-capturing assembly 805 (e.g., a lens and an image sensor). Also, the hardware components of head-mounted display device 800 communicate by means of one or more buses or other electrical connections. Examples of buses include a universal serial bus (USB), an IEEE 1394 bus, a PCI bus, an Accelerated Graphics Port (AGP) bus, a Serial AT Attachment (SATA) bus, and a Small Computer System Interface (SCSI) bus.

The one or more processors 801 include one or more central processing units (CPUs), which include microprocessors (e.g., a single core microprocessor, a multi-core microprocessor); graphics processing units (GPUs); or other electronic circuitry. The one or more processors 801 are configured to read and perform computer-executable instructions, such as instructions that are stored in the storage 803. The I/O interfaces 802 include communication interfaces to input and output devices, which may include a keyboard, a display, a mouse, a printing device, a touch screen, a light pen, an optical-storage device, a scanner, a microphone, a camera, a drive, a controller (e.g., a joystick, a control pad), a network interface controller, and the image-generation device 810.

The storage 803 includes one or more computer-readable storage media. As used herein, a computer-readable storage medium, in contrast to a mere transitory, propagating signal per se, refers to a computer-readable media that includes a tangible article of manufacture, for example a magnetic disk (e.g., a floppy disk, a hard disk), an optical disc (e.g., a CD, a DVD, a Blu-ray), a magneto-optical disk, magnetic tape, and semiconductor memory (e.g., a non-volatile memory card, flash memory, a solid-state drive, SRAM, DRAM, EPROM, EEPROM). Also, as used herein, a transitory computer-readable medium refers to a mere transitory, propagating signal per se, and a non-transitory computer-readable medium refers to any computer-readable medium that is not merely a transitory, propagating signal per se. The storage 803, which may include both ROM and RAM, can store computer-readable data or computer-executable instructions.

The head-mounted display device 800 also includes a display-operation module 803A and a communication module 803B. A module includes logic, computer-readable data, or computer-executable instructions, and may be implemented in software (e.g., Assembly, C, C++, C#, Java, BASIC, Perl, Visual Basic), hardware (e.g., customized circuitry), or a combination of software and hardware. In some embodiments, the devices in the system include additional or fewer modules, the modules are combined into fewer modules, or the modules are divided into more modules. When the modules are implemented in software, the software can be stored in the storage 803.

The display-operation module 803A includes instructions that, when executed, or circuits that, when activated, cause the head-mounted display device 800 to render images on the display 804, for example images received from the image-generation device 810.

The communication module 803B includes instructions that, when executed, or circuits that, when activated, cause the head-mounted display device 800 to communicate with one or more other devices, for example the image-generation device 810.

The image-generation device 810 includes one or more processors 811, one or more I/O interfaces 812, and storage 813, and the hardware components of the image-generation device 810 communicate by means of a bus. The image-generation device 810 also includes a menu-generation module 813A, an image-generation module 813B, a settings-control module 813C, an input-control module 813D, a communication module 813E, and camera and lens information 813F.

The menu-generation module 813A includes instructions that, when executed, or circuits that, when activated, cause the image-generation device 810 to generate a menu, for example a main menu, a camera-selection menu, a lens-selection menu, and a settings menu. In some embodiments, the menu-generation module 813A sends a generated menu to the image-generation module 813B.

The image-generation module 813B includes instructions that, when executed, or circuits that, when activated, cause the image-generation device 810 to generate one or more images, for example viewfinder images, captured images of the virtual scene, or respective images of menus. The viewfinder image and captured images are generated based on the specifications of a selected camera, the specifications of a selected lens, the selected settings values of the selected camera, and the selected settings values of the selected lens.

The settings-control module 813C includes instructions that, when executed, or circuits that, when activated, cause the image-generation device 810 to manage the values of the settings of a selected camera and a selected lens. This may include, for example, changing the settings values for a camera or a lens.

The input-control module 813D includes instructions that, when executed, or circuits that, when activated, cause the image-generation device 810 to receive and interpret signals from one or more input devices, for example a keyboard, a controller, a mouse, and the head-mounted display device 800. For example, the signals may indicate a change of the zoom of a lens, a change of the focus of the lens, a selection of a setting, a selection of a camera, a selection of a lens, a change in a value of a setting, a change in the position of the head-mounted display device 800, and a change in the orientation of the head-mounted display device 800.

The communication module 813E includes instructions that, when executed, or circuits that, when activated, cause the image-generation device 810 to communicate with one or more other devices, for example the head-mounted display device 800.

The camera and lens information 813F includes information about the specifications of cameras and lenses. For example, these specifications may include sensor size, sensor resolution, minimum ISO, maximum ISO, autofocus points, exposure metering, focal length, chromatic aberration, maximum zoom, minimum zoom, maximum aperture, minimum aperture, and optical image-stabilization.

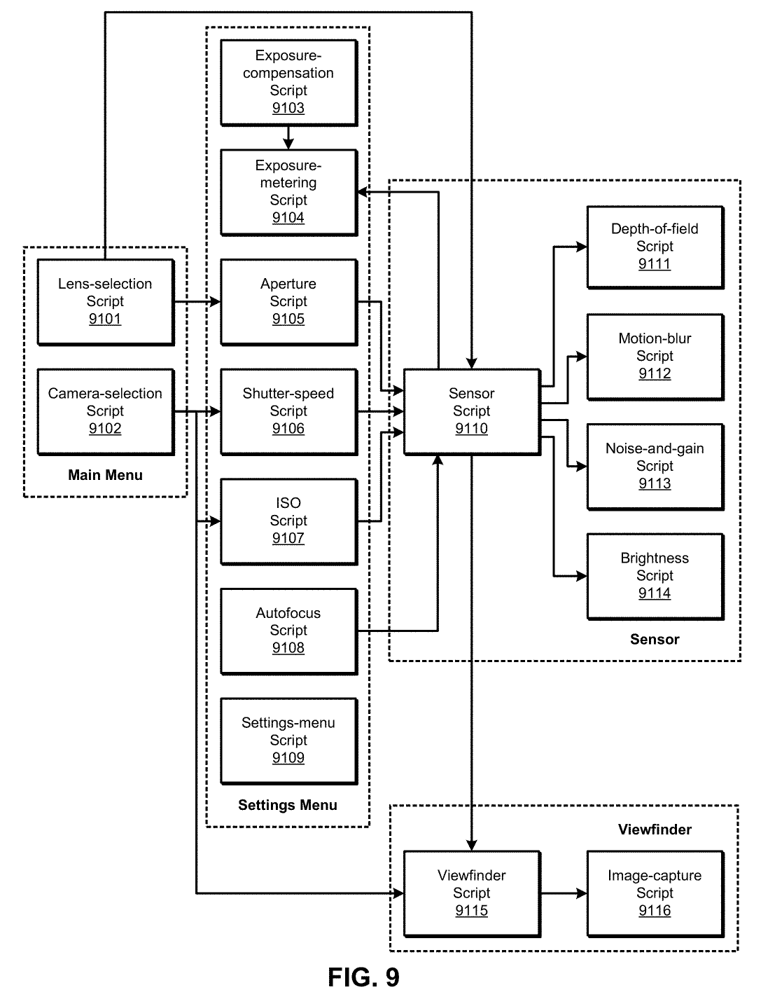

FIG. 9 illustrates the scripts that can be used to implement the operations of some embodiments of a virtual-reality camera-simulator system. In general, information flows from left to right in this figure. The scripts are organized into four groups: a “main menu” group, a “settings menu” group, a “sensor” group, and a “viewfinder” group. Some embodiments of a virtual-reality camera-simulator system include additional scripts or different scripts, and in some embodiments only the scripts that are illustrated in FIG. 9 control what appears in a viewfinder image and a captured image.

The “main menu” group includes a lens-selection script 9101 and a camera-selection script 9102. The lens-selection script 9101 generates a lens-selection menu and receives a selection of a lens. The camera-selection script 9102 generates a camera-selection menu and receives a selection of a camera. These scripts then pass the selections and their respective parameters to some scripts in the “settings menu” group, the “sensor” group, and the “viewfinder” group.

The “settings menu” group includes an exposure-compensation script 9103, an exposure-metering script 9104, an aperture script 9105, a shutter-speed script 9106, an ISO script 9107, an autofocus script 9108, and a settings-menu script 9109. The settings-menu script 9109 controls the presentation of a settings menu, and the other scripts in the “settings menu” group control respective buttons (or other input means, such as sliders, text boxes, etc.) on the settings menu. Also, the aperture script 9105, the shutter-speed script 9106, the ISO script 9107, and the autofocus script 9108 control respective setting values that are communicated to a sensor script 9110.

The exposure-metering script 9104 uses information that it receives from the sensor script 9110 and from the exposure-compensation script 9103 to control the appearance of an exposure meter on the settings menu or in a display of camera-setting information. In a real-world camera, the exposure meter is a tool that can be used to determine if a scene or photo is correctly exposed. This may be done by sampling the pixels on various parts of the viewfinder and calculating a weighted-average luminance value from the sampled pixels. For example, some cameras have four different sampling or metering modes: evaluative, partial, spot, and center-weighted metering. Spot, partial, and center-weighted metering modes sample an area at the center of the view in sizes that increase in the order mentioned. Evaluative metering samples an area centered at a point of focus.

In some embodiments of a virtual-reality camera-simulator system, exposure metering is most similar to spot metering (i.e., sampling an area of pixels at the center of the view with equal weights). Each pixel within a square area at the center of the view is sampled for its RGB value. This sampling area may be kept small in order to minimize the computational load of calculating the luminance of each pixel. Even in embodiments that are more similar to other metering modes, sampling a large number of small areas may be more efficient and also more representative of the whole view.

Additionally, luminance may be relative to a nominal value. The exposure-metering script 9104 may multiply the individual red, green, and blue intensity values (ranging from 0 to 255) of a pixel by respective weights of the colors to find the relative luminance value for that pixel. The weights that are used may be taken from the official documentation of the standard sRGB color space, which are shown in the equation below:

Relative Luminance=0.2126* Red+0.7152* Blue+0.0722*Green.

The exposure-metering script 9104 may calculate the average relative luminance of the sampled area by dividing the sampled area by the number of pixels sampled (the square of the sampling-area-edge length).

Additionally, a nominal luminance value may be empirically determined through observing the average luminance values of photos that are considered correctly exposed. The sampled average luminance value may be compared to this nominal luminance value by taking their difference. The result is a relative luminance decimal value. The positive and negative sign of the decimal value indicates if the scene is overexposed or underexposed, respectively.

The brightness of an exposure or scene may be characterized by an exposure value (EV). In some embodiments, the EV can be described by the following:

$$EV = \frac{Average Relative Luminance - Nominal Relative Luminance}{Luminance Bracket} .$$

A unit of EV is typically known as a stop, which are the integer values displayed on exposure meters. One EV stop is typically broken into three sub-stops.

In order to display the calculated relative luminance value in terms of EV stops, the relative luminance value can be normalized. This may be done by dividing the relative luminance by a luminance-bracket value. The luminance-bracket value is a positive decimal that indicates the relative luminance value that corresponds to 1 EV sub-stop. The rounded quotient of the division is the number of EV sub-stops above or below zero on the exposure meter. For example, in some embodiment an EV stop can be determined as follows:

$$EV = \frac{Relative Luminance}{Luminance - Bracket Value} .$$

Some embodiments of the virtual-reality camera-simulator system use other metering methods, such as weighted-metering methods. One metering method, evaluative metering, samples a large area centered at the autofocus point, with the pixels towards the center being weighted higher than those towards the edge of the area. And in a manual mode, some embodiments simply offset the exposure meter by the number of EV stops set for exposure compensation. Thus, the implementation for exposure compensation may simply take an EV step between −2 and 2, and offset the exposure meter.

The autofocus script 9108 may implement operations that emulate a real-world autofocus system. When the user inputs an autofocus command, a ray may be emitted from a virtual camera object in the virtual scene, which represents the sensor, and continue until it hits a collider object in the virtual scene. The ray can then report the collider object to the sensor. The distance in the virtual scene between the sensor and the collider object may then be obtained through vector subtraction.

Also, the autofocus script 9108 may not focus instantaneously, but do so gradually to simulate a real-world camera, which must adjust physical lens elements. And the focus-distance parameter of the autofocus script 9108, which simulates the depth of field and may be sent to the sensor script 9110, may be increased linearly as long as the user holds down an autofocus button.

The settings values from the scripts in the “settings menu” group are communicated to the “sensor” group through the sensor script 9110, and the sensor script 9110 also manages the other scripts in the “sensor group.” The other scripts in the “sensor” group are a depth-of-field script 9111, a motion-blur script 9112, a noise-and-gain script 9113, and a brightness script 9114. Each of these other scripts controls a respective aspect of the appearance of an image.

For example, the depth-of-field script 9111 simulates the depth of field of an image, and the depth-of-field script 9111 may simulate the depth of field using a script and a shader. Also, the depth-of-field script 9111 may operate based on three parameters: focal distance, focal size, and aperture.

Focal distance is the distance from a virtual sensor that is perfectly in focus. In a real-world camera (i.e., a non-virtual camera), the focal distance can be adjusted by means of the focus rings on the lens of the camera or by the camera's autofocus feature. Generally, in a real-world lens, the focal distance increases in a nonlinear fashion and eventually reaches infinity within a few revolutions of the focus ring. However, the focal distance in a virtual-reality camera-simulator system may be adjusted using other inputs, for example the left and right arrow keys. Additionally, the value of the focal distance may increase in a linear fashion, but never reach infinity.

The focal-size parameter describes the range around the focal distance that is in focus. A large focal size means that everything is in focus regardless of focal distance.

The aperture parameter is the equivalent of the real-world aperture-size. Aperture size values are generally shown as a number after “f/” (e.g., f/1.4). This represents a decimal value out of 1 (e.g., f/1.4 is equivalent to 1/1.4 or 0.714). The aperture parameter takes a value between 0 and 1, so its value is the decimal obtained from dividing 1 by the aperture number set in the settings. This value can be changed from the settings menu.

Also for example, the motion-blur script 9112 may use a script and a shader. The shader may combine the current image with a number of past image images (subject to a parameter) with less opacity, thereby creating a blur effect. And the motion-blur script 9112 may accept a blur-amount parameter that describes the amount of blur. The blur-amount parameter may be relatively sensitive, and a very small change in the blur-amount parameter may yield a large amount of motion blur. Thus, the blur-amount parameter may be calibrated visually by matching the amount of blurring in a real-world camera at certain shutter speeds. Also, the pattern of increases may be linear (e.g., with a slope of 2).

Additionally, the noise-and-gain script 9113 may simulate noise using a script and a shader. Although the noise-and-gain script 9113 may use many parameters, some embodiments use only a general-intensity parameter. The parameter may be relatively sensitive (e.g., a value of 0.032 may induce a significant amount of noise). Furthermore, the level of noise in an image correlates with the ISO value used when the sensor captures the image, and the level of noise is also affected by the amount of light present in the scene. Thus, the general-intensity parameter may be calibrated visually by inspecting the level of noise at each ISO value and comparing them to real-world camera outputs. The pattern of increase may be linear (e.g., with a slope of 0.00002). Such embodiments may ignore the effect of varying amounts of light in the scene. However, the noise pixels may be less noticeable in brighter scenes, and thus the overall effect may appear to be visually accurate.

Moreover, the brightness script 9114 may be used to represent exposure. In a real-world camera, exposure is primarily affected by three settings: aperture, shutter speed, and ISO. Each of these settings affects a different aspect of the resulting photo, while contributing to the overall brightness of the exposure. But for the purpose of simulating exposure, some embodiments of virtual-reality camera-simulator systems use brightness to represent exposure, and some embodiments of the brightness script 9114 simulate brightness using a script and shader. The brightness may be adjusted by changing the brightness parameter of the brightness script 9114, which may be a floating-point coefficient to the default rendering brightness (e.g., a value of 1 does not result in any change). Because brightness is affected by aperture, shutter speed, and ISO, the floating-point coefficient is a function of the values of the three settings.

As each setting's numerical value may vary greatly, sometimes with differences in orders of magnitudes (e.g., numerical ISO values are in the scale of hundreds and thousands, while shutter speed values are fractions), they may be normalized. This may be performed by selecting a nominal value for each setting, and dividing the setting value by this nominal value to produce a decimal multiplier. When the setting is set at the nominal value, the normalized multiplier will be 1, and thus will not contribute any change to the overall brightness through the weighted average. Thus, the nominal value can be defined as a numerical value of a setting that would cause no effect to the overall brightness or exposure of the image.

However, an increase in the numerical value of a setting will not always result in increased brightness in the captured image. Aperture is an example of a setting that has a value that has an inverse relationship with brightness. The aperture f-stop number increases as the physical diameter of the aperture decreases, causing the exposure to be darker. This may be accounted for by taking the inverse of the f-stop value and representing the aperture with a fraction where the f-stop number is the denominator.

Some embodiments of the virtual-reality camera-simulator system implement a linear relationship between the impact of the setting value on brightness and the setting value itself. However, some embodiment may implement more complex, nonlinear relationships. The brightness coefficient may be calculated as a weighted average of the values of the three setting (aperture, shutter speed, and ISO). The normalized value of each setting may be multiplied by a respective weight to calculate the weighted average. These weights may be empirically chosen by observing the real-world effects of the three settings (aperture, shutter speed, ISO) on the brightness of a resulting image. For example, in some embodiments the brightness can be described by the following:

$$Brightness = {W}_{aperture} * \frac{aperture}{{aperture}_{nominal}} + {W}_{shutter speed} * \frac{shutter speed}{shutter {speed}_{nominal}} + {W}_{ISO} * \frac{ISO}{{ISO}_{nominal}}$$

The weights and nominal values used may be calibrated by visually comparing the viewfinder image to the exposure of a real-world camera.

The “sensor” group may include other scripts that apply respective effects to an image. For example, a script that simulates common lens artifacts, such as vignette and chromatic aberration, may be used to create these effects on the viewfinder image or the captured image. Additionally, the sensor script 9110 may pass an image's rendered texture through an anti-aliasing filter to produce sharper edges.

The “viewfinder” group includes a viewfinder script 9115 and an image-capture script 9116. The viewfinder script 9115 receives image information (e.g., blur, depth of field, brightness, noise, focal plane) from the camera-selection script 9102 and from the sensor script 9110 and renders an image of the scene according to the received image information.

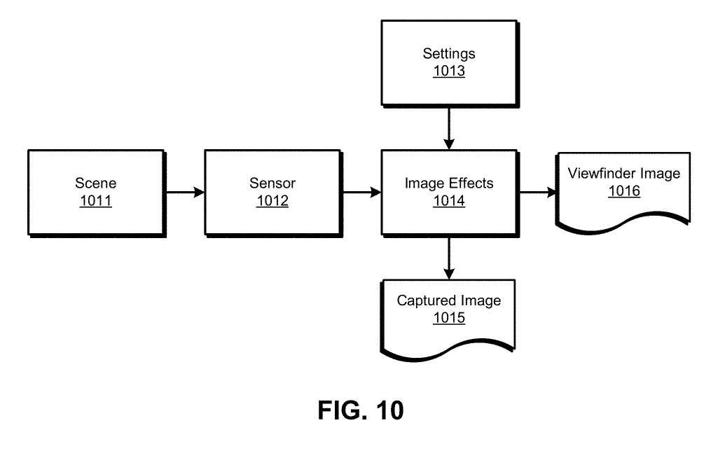

FIG. 10 illustrates the general flow of information in some embodiments of a virtual-reality camera-simulator system. A virtual scene 1011 is captured by the virtual sensor 1012 of a virtual camera, and the virtual sensor 1012 produces an image of the virtual scene 1011, for example by rendering the scene 1011 into a flat texture of a specific size that is based on the size of the virtual sensor 1012. The image of the virtual scene is sent to image effects 1014, which implements scripts that add effects to the virtual image, for example by means of specific shaders. The scripts that add the effects operate according to the settings 1013.

The processed image (e.g., the processed texture) can be the viewfinder image 1016 or the captured image 1015. In some embodiments, the viewfinder image 1016 is an image that appears to show the virtual scene at a short distance away from the virtual camera, and the viewfinder image 1016 is the a view that is displayed by a head-mounted display device. This may make the viewfinder image 1016 in these embodiments more similar to an electronic viewfinder (EVF) than an optical viewfinder, in that it displays what the captured image would look like. The captured image 1015 may be an image from the sensor 1012 that has been modified only by the image effects 1014.

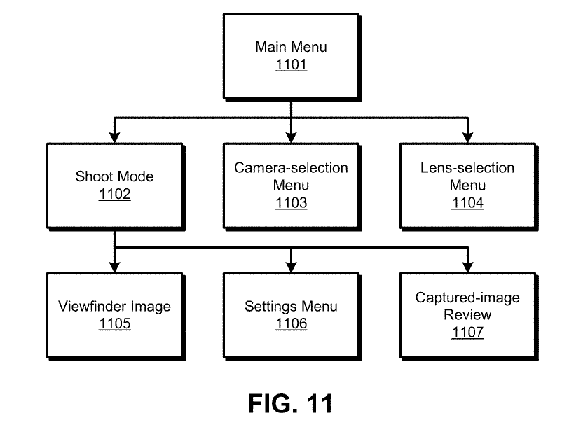

FIG. 11 illustrates the menu and mode organization in some example embodiments of a virtual-reality camera-simulator system. A main menu 1101 has three options: a shoot mode 1102, a camera-selection menu 1103, and a lens-selection menu 1104. The shoot mode 1102 has three options: a viewfinder image 1105, a settings menu 1106, and captured-image review 1107. The captured-image review 1107 presents captured images on the head-mounted display device. In the shoot mode 1102, a user can toggle between the viewfinder image 1105, the settings menu 1106, and the captured-image review 1107.

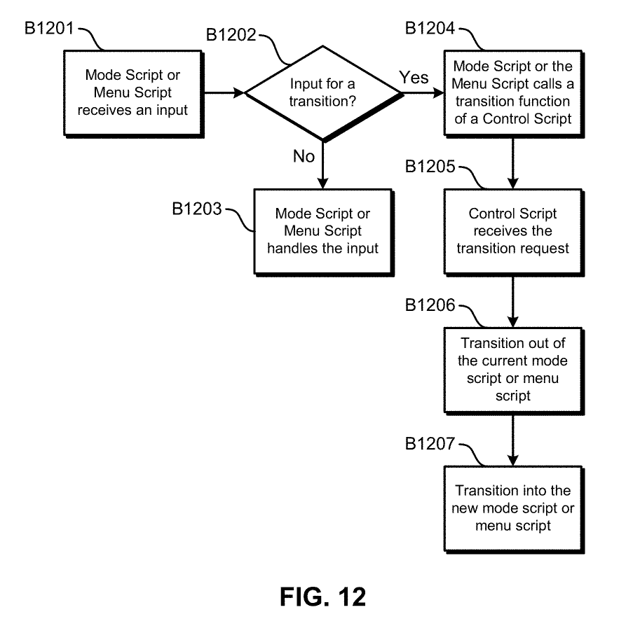

FIG. 12 illustrates an example embodiment of an operational flow for menu and mode transitions. The flow starts in block B1201, where a mode script or a menu script in a virtual-reality camera-simulator system receives an input.

Examples of mode scripts include the exposure-compensation script 9103, the exposure-metering script 9104, the aperture script 9105, the shutter-speed script 9106, the ISO script 9107, the autofocus script 9108, the settings-menu script 9109, the sensor script 9110, the depth-of-field script 9111, the motion-blur script 9112, the noise-and-gain script 9113, the brightness script 9114, the viewfinder script 9115, and the image-capture script 9116 in FIG. 9. Examples of menu scripts include the lens-selection script 9101, the camera-selection script 9102, and the settings-menu script 9109 in FIG. 9.

Next, in block B1202, the mode script or the menu script determines if the input is an input for a transition to another mode or another menu. If not (block B1202=No), then the flow moves to block B1203, where the mode script or the menu script handles the input. If yes (block B1202=Yes), then the flow proceeds to block B1204.

In block B1204, the mode script or the menu script calls a transition function of a control script. Next, in block B1205, the control script receives the transition request in the call. The flow then moves to block B1206, where the virtual-reality camera-simulator system transitions out of the current mode script or menu script. Finally, in block B1207, the virtual-reality camera-simulator system transitions into the new mode script or menu script.

Some embodiments use one or more functional units to implement the above-described devices, systems, and methods. The functional units may be implemented in only hardware (e.g., customized circuitry) or in a combination of software and hardware (e.g., a microprocessor that executes software).

The scope of the claims is not limited to the above-described embodiments and includes various modifications and equivalent arrangements. Also, as used herein, the conjunction “or” generally refers to an inclusive “or,” though “or” may refer to an exclusive “or” if expressly indicated or if the context indicates that the “or” must be an exclusive “or.”

What is claimed is:

1. A device comprising:
one or more computer-readable media; and
one or more processors that are coupled to the one or more computer-readable media and that are configured to cause the device to
receive a user selection of a camera option, wherein the camera option describes one or more specifications of a corresponding camera;
receive a user selection of a lens option, wherein the lens option describes one or more specifications of a corresponding lens;
generate first images of a scene according to the one or more specifications of the corresponding camera, respective values of camera settings, the one or more specifications of the corresponding lens, and respective values of lens settings;
send the first images to a head-mounted display device;
receive an input that indicates a new value for a selected camera setting or a selected lens setting;
update the value of the selected camera setting or the selected lens setting to the new value;
generate second images of the scene according to the one or more specifications of the corresponding camera, the respective values of the camera settings, the one or more specifications of the corresponding lens, and the respective values of the lens settings, wherein the respective values of the camera settings or the respective values of the lens settings include the new value; and
send the second images to a head-mounted display device.

2. The device of claim 1, wherein the one or more processors are further configured to cause the device to
receive a request to display a settings-value menu; and
add the settings-value menu to the second images.

3. The device of claim 1, wherein the new value for a selected camera setting or a selected lens setting is a new value of an exposure setting, and
wherein, to generate the second images of the scene, the one or more processors are further configured to cause the device to adjust a brightness of the scene according to the new value of the exposure setting.

4. The device of claim 1, wherein the one or more processors are further configured to cause the device to
implement a respective script for each camera setting and each lens setting, wherein the respective script of a setting manages the value of the setting.

5. The device of claim 1, wherein the one or more processors are further configured to cause the device to
receive information from the head-mounted display device that indicates a new position or a new orientation of the head-mounted display device; and
generate third images of the scene according to the one or more specifications of the corresponding camera, the respective values of the camera settings, the one or more specifications of the corresponding lens, and the respective values of the lens settings, wherein the respective values of the camera settings or the respective values of the lens settings include the new value, and wherein the third images depict the scene from the new position or the new orientation of the head-mounted display device.

6. The device of claim 1, wherein the one or more processors are further configured to cause the device to
add camera-setting information to the first images, wherein the camera-setting information indicates respective values for camera settings; and
add the camera-setting information to the second images.

7. One or more computer-readable storage media storing computer-executable instructions that, when executed by one or more computing devices, cause the computing device to perform operations comprising:
receiving a user selection of a camera option, wherein the camera option describes one or more specifications of a corresponding camera;
receiving a user selection of a lens option, wherein the lens option describes one or more specifications of a corresponding lens;
generating a virtual scene;
generating first images of the virtual scene according to the one or more specifications of the corresponding camera, respective values of camera settings, the one or more specifications of the corresponding lens, and respective values of lens settings;
sending the first images to a head-mounted display device;
receiving an input that indicates a new value for a selected camera setting or a selected lens setting;
updating the value of the selected camera setting or the selected lens setting to the new value;
generating second images of the virtual scene according to the one or more specifications of the corresponding camera, the respective values of the camera settings, the one or more specifications of the corresponding lens, and the respective values of the lens settings, wherein the respective values of the camera settings or the respective values of the lens settings include the new value; and
sending the second images to a head-mounted display device.

8. The one or more computer-readable storage media of claim 7, wherein the operations further comprise:
adding noise to the first images and to the second images according to a value of an ISO setting.

9. The one or more computer-readable storage media of claim 7, wherein the new value for the selected camera setting or the selected lens setting is a new value for a focus setting of the corresponding lens, and
wherein a focus of the second images is different from a focus of the first images.

10. The one or more computer-readable storage media of claim 7, wherein the new value for the selected camera setting or the selected lens setting is a new value for a zoom setting of the corresponding lens, and
wherein a zoom of the second images is different from a zoom of the first images.

11. The one or more computer-readable storage media of claim 7, wherein the operations further comprise:
receiving a request to display a settings-value menu; and
adding the settings-value menu to the second images.

12. The one or more computer-readable storage media of claim 11, wherein the operations further comprise:
receiving a request to stop displaying the settings-value menu; and
removing the settings-value menu from the second images.

13. The one or more computer-readable storage media of claim 7, wherein the new value for the selected camera setting or the selected lens setting is a new value for a shutter-speed setting of the corresponding camera; and
wherein, in response to the new value for the shutter-speed setting, some areas of the scene are made to appear more blurry in the second images than in the first images.

14. A method comprising:
receiving a user selection of a camera option, wherein the camera option describes one or more specifications of a corresponding camera;
receiving a user selection of a lens option, wherein the lens option describes one or more specifications of a corresponding lens;
generating a virtual scene;
generating first images of the virtual scene according to the one or more specifications of the corresponding camera, respective values of camera settings, the one or more specifications of the corresponding lens, and respective values of lens settings;
sending the first images to a head-mounted display device;
receiving an input that indicates a new value for a selected camera setting or a selected lens setting;
updating the value of the selected camera setting or the selected lens setting to the new value;
generating second images of the virtual scene according to the one or more specifications of the corresponding camera, the respective values of the camera settings, the one or more specifications of the corresponding lens, and the respective values of the lens settings, wherein the respective values of the camera settings or the respective values of the lens settings include the new value; and
sending the second images to a head-mounted display device.

15. The method of claim 14, further comprising:
receiving information from the head-mounted display device that describes an orientation and a position of the head-mounted display device in the virtual scene;
wherein the first images of the virtual scene are generated further according to the orientation and the position of the head-mounted display device in the virtual scene; and
wherein the second images of the virtual scene are generated further according to the orientation and the position of the head-mounted display device in the virtual scene.
